(19) United States
(12) Patent Application Publication
(10) Pub. No.: US 2007/0014576 A1
(43) Pub. Date: Jan. 18, 2007

(54) Bidirectional add/drop multiplexer

(75) Inventors: Sung-Bum Park, Suwon-si (KR); Seong-Taek Hwang, Pyeongtaek-si (KR); Hyun-Soo Kim, Suwon-si (KR); Dae-Kwang Jung, Suwon-si (KR); Hong-Seok Shin, Suwon-si (KR); Dong-Jae Shin, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/403,757

(22) Filed: Apr. 13, 2006

(30) Foreign Application Priority Data
Jul. 18, 2005 (KR) 2005-64710

(51) Int. Cl. H04J 14/02

(52) U.S. Cl. 398/83

(57) ABSTRACT

A bidirectional add/drop multiplexer includes first input/output unit inputs a first optical signal multiplexed from a plurality of odd channels and outputs a second optical signal multiplexed from a plurality of added or dropped even channels; a second input/output unit outputs the first optical signal multiplexed from a plurality of added or dropped odd channels and outputs the second optical signal multiplexed from a plurality of even channels; an optical arrayed waveguide grating for multiplexing added or dropped odd channels of the first optical signal input to a first terminal for subsequent transmission to the second input/output unit, multiplexing added or dropped even channels of the second optical signal input to a second terminal for subsequent transmission to the first input/output unit; and an optical combining unit that amplifies the first optical signal and the second optical signal input from the first input/output unit and the second input/output unit.

### CLAIM OF PRIORITY

This application claims priority under 35 U.S.C. § 119 to an application entitled “Bidirectional Add/Drop Multiplexer,” filed in the Korean Intellectual Property Office on Jul. 18, 2005 and assigned Serial No. 2005-64710, the contents of which are incorporated herein by reference.

### BACKGROUND OF THE INVENTION

1. Field of the Invention

The present invention generally relates to an add/drop multiplexer, and in particular, to a bidirectional add/drop multiplexer capable of amplifying an optical signal that is bidirectionally communicated.

2. Description of the Related Art

The spread of the Internet and various communication media increases the number of users and their demands for communication traffic. A metro core network for linking a core node between metro cities has been suggested to effectively satisfy the increasing communication needs.

In particular, the metro core network using wavelength division multiplexing uses a plurality of wavelengths to transmit signals irrespective of a transmission method or a transmission speed, thereby realizing a high-speed and broad-band communication network.

Each core node in the metro core network includes add/drop multiplexers capable of dropping a desired channel and adding a specific channel. The add/drop multiplexers include amplifiers for compensating the loss of optical signals which may occur while the optical signals pass through a plurality of core nodes.

FIG. 1 illustrates a bidirectional add/drop multiplexer 100 according to prior art. Referring to FIG. 1, the bidirectional add/drop multiplexer 100 includes an optical arrayed waveguide grating 110 including N×N input/output ports, two interleavers 134 and 144, two three-terminal optical rotators 132 and 142, two optical isolators 135 and 145, two bidirectional optical amplifiers 131 and 141, two unidirectional optical amplifiers 133 and 143, and a mid-stage device 120.

After dropping a specific channel among channels forming a first optical signal and a second optical signal and adding another specific channel to the channels, the optical arrayed waveguide grating 110 multiplexes the remaining channels and the added channel and outputs the same to paths.

However, a bidirectional add/drop multiplexer according to prior art includes a number of optical amplifiers, thus increasing the installation cost.

### SUMMARY OF THE INVENTION

The present invention provides an economical bidirectional add/drop multiplexer capable of performing amplification and add/drop operations.

In one embodiment, there is provided a bidirectional add/drop multiplexer including a first input/output unit, a second input/output unit, an optical arrayed waveguide grating, and an optical combining unit. The first input/output unit inputs a first optical signal multiplexed from a plurality of odd channels and outputs a second optical signal multiplexed from a plurality of added or dropped even channels. The second input/output unit outputs the first optical signal multiplexed from a plurality of added or dropped odd channels and outputs the second optical signal multiplexed from a plurality of even channels. The optical arrayed waveguide grating includes a first terminal and a second terminal, each of which includes a plurality of ports. The optical arrayed waveguide grating multiplexes added or dropped odd channels of the first optical signal input to the first terminal, outputs the multiplexed even channels to the second input/output unit through the first terminal, multiplexes added or dropped even channels of the second optical signal input to the second terminal, and outputs the multiplexed even channels to the first input/output unit through the second terminal. The optical combining unit amplifies the first optical signal and the second optical signal input from the first input/output unit and the second input/output unit and outputs the first optical signal to the first terminal and the second optical signal to the second terminal.

### BRIEF DESCRIPTION OF THE DRAWINGS

The above features and advantages of the present invention will become more apparent from the following detailed description when taken in conjunction with the accompanying drawings in which:

FIG. 1 illustrates a bidirectional add/drop multiplexer according to prior art;

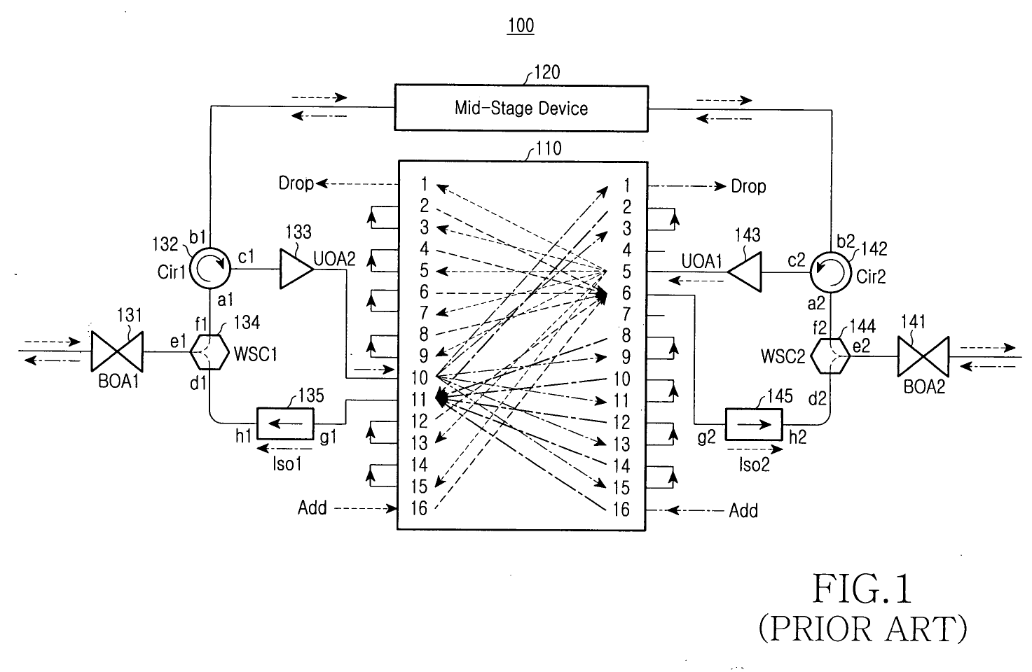

FIG. 2 illustrates a bidirectional add/drop multiplexer according to a first embodiment of the present invention;

FIG. 3 illustrates a bidirectional add/drop multiplexer according to a second embodiment of the present invention; and

FIG. 4 illustrates a bidirectional add/drop multiplexer according to a third embodiment of the present invention.

### DETAILED DESCRIPTION

Hereinafter, embodiments of the present invention will now be described in detail with reference to the annexed drawings. For the purposes of clarity and simplicity, a detailed description of known functions and configurations incorporated herein has been omitted for conciseness.

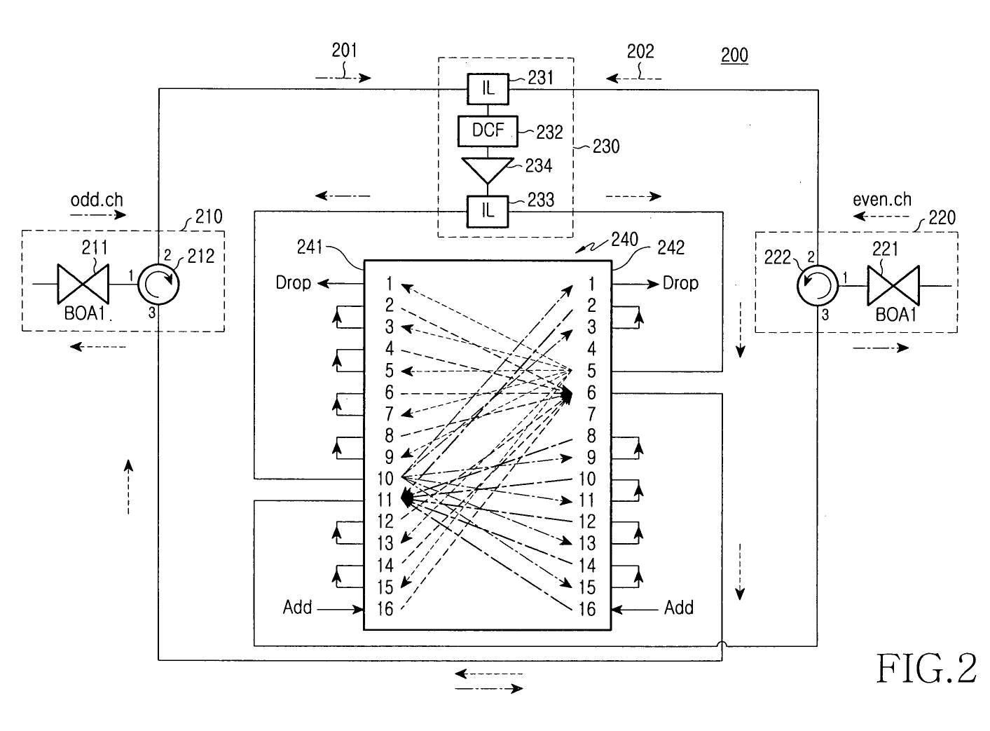

FIG. 2 illustrates a bidirectional add/drop multiplexer 200 according to a first embodiment of the present invention. As shown, the bidirectional add/drop multiplexer 200 includes a first input/output unit 210 for inputting a first optical signal odd.ch 201 multiplexed from a plurality of odd channels and outputting a second optical signal even.ch 202 multiplexed from a plurality of added or dropped even channels, a second input/output unit 220 for outputting the first optical signal odd.ch 201 multiplexed from a plurality of added or dropped odd channels and inputting the second optical signal even.ch 202 multiplexed from a plurality of even channels, an optical arrayed waveguide grating 240, and an optical combining unit 230 for amplifying the first optical signal 201 and the second optical signal 202 output from the first input/output unit 210 and the second input/output unit 220, respectively, and then outputting them to the optical arrayed waveguide grating 240.

The first input/output unit 210 includes a second optical amplifier 211 for amplifying the first optical signal 201 and the second optical signal 202, and a first circulator 212 for outputting the first optical signal 201 amplified by the second optical amplifier 211 to the optical combining unit 230 and outputting the second optical signal 202 output from a second terminal 242 of the optical arrayed waveguide grating 240 to the second optical amplifier 211. The first circulator 212 includes -first through third ports. The first port is connected to the second optical amplifier 211, the second port is connected to the optical combining unit 230, and the third port is connected to a port (port 6) of the second terminal 242 of the optical arrayed waveguide grating 240.

Meanwhile, the second optical amplifier 211 amplifies the first optical signal 201 multiplexed from a plurality of different odd channels input from outside the bidirectional add/drop multiplexer 200, amplifies the second optical signal 202 multiplexed from even channels added or dropped at the optical arrayed waveguide grating 240, and outputs the amplified first optical signal 201 and the amplified second optical signal 202 to outside the bidirectional add/drop multiplexer 200.

The second input/output unit 220 includes a third optical amplifier 221 for amplifying the first optical signal 201 and the second optical signal 202, and a second circulator 222 for outputting the second optical signal 202 amplified by the third optical amplifier 221 to the optical combining unit 230 and outputting the first optical signal 201 output from a first terminal 241 of the optical arrayed waveguide grating 240 to the third optical amplifier 221. The second circulator 222 includes first through third ports. The first port is connected to the third optical amplifier 221, the second port is connected to the optical combining unit 230, and the third port is connected to a port (port 11) of the first terminal 241 of the optical arrayed waveguide grating 240.

The third optical amplifier 221 amplifies the second optical signal 202 multiplexed from a plurality of different even channels input from outside the bidirectional add/drop multiplexer 200, outputs the amplified second optical signal 202 to the optical combining unit 230, amplifies the first optical signal 201 multiplexed from odd channels added or dropped at the optical arrayed waveguide grating 240, and outputs the amplified first optical signal 201 to outside the bidirectional add/drop multiplexer 200.

Note that the second optical amplifier 211 and the third optical amplifier 221 are bidirectional optical amplifiers and may be semiconductor optical amplifiers or optical fiber amplifiers.

The optical combining unit 230 includes a first interleaver 231 connected to the first input/output unit 210 and the second input/output unit 220 for inputting the first optical signal 201 and the second optical signal 202 from the first input/output unit 210 and the second input/output unit 220, respectively, to the optical combining unit 230, a second interleaver 233 for outputting the first optical signal 201 input from the first interleaver 231 to a port (port 10) of the first terminal 241 and outputting the second optical signal 202 to a port (port 5) of the second terminal 242, a first optical amplifier 234 positioned between the first interleaver and the second interleaver 233 for amplifying the first optical signal 201 and the second optical signal 202 and outputting the amplified first optical signal 201 and the amplified second optical signal 202 to the second interleaver 233, and a dispersion compensating fiber 232 for connecting the first optical amplifier 234 and the first interleaver 231.

The first optical amplifier 234 is a unidirectional optical amplifier and may be a semiconductor optical amplifier and an optical fiber amplifier.

The optical arrayed waveguide grating 240 includes a first terminal 241 and a second terminal 242, each of which includes a plurality of ports 1-16. The optical arrayed waveguide grating 240 multiplexes added or dropped odd channels of the first optical signal 201 input to the first terminal 241, outputs the multiplexed odd channels to the second input/output unit 220 through a port (port 11) of the first terminal 241, multiplexes added or dropped even channels of the second optical signal 202 input to a port (port 5) of the second terminal 242, and outputs the multiplexed channels to the first input/output unit 210 through a port (port 6) of the second terminal 242.

If each of the first optical signal 201 and the second optical signal 202 includes 7 channels, each of the first terminal 241 and the second terminal 242 of the optical arrayed waveguide grating 240 includes 16 ports 1-16. The first optical signal 201 is input to the port 10 of the first terminal 241 through the optical combining unit 230.

The optical arrayed waveguide grating 240 demultiplexes the first optical signal 201 input to the port 10 of the first terminal 241 into odd channels and outputs the odd channels to the ports 1, 3, 9, 11, 13, and 15 of the second terminal 242. The odd channel output to the port 1 of the second terminal 242 is dropped and an odd channel of a predetermined wavelength is added at the port 16 of the second terminal 242.

The odd channels output to the ports 3, 9, 11, 13, and 15 of the second terminal 242 are folded back to the first terminal 241 of the optical arrayed waveguide grating 240 through the ports 2, 8, 10, 12, and 14 of the second terminal 242 adjacent to the ports 3, 9, 11, 13, and 15. The odd channels folded back to the first terminal 241 of the optical arrayed waveguide grating 240 and the odd channel added at the port 16 of the second terminal 242 are multiplexed into the first optical signal 201 at the optical arrayed waveguide grating 240, and the first optical signal 201 is output to the port 11 of the first terminal 241 of the optical arrayed waveguide grating 240 connected to the third port of the second circulator 221.

The second optical signal 202 is input to the port 5 of the second terminal 242 of the optical arrayed waveguide grating 240 through the optical combining unit 230. The second optical signal 202 input to the port 5 of the second terminal 242 is demultiplexed into even channels having different wavelengths at the optical arrayed waveguide grating 240, and the even channels are output to the ports 1, 3, 5, 7, 9, 13, and 15 of the first terminal 241. The even channel output to the port 1 of the first terminal 241 is dropped, and an even channel of a predetermined wavelength is added from outside at the port 16 of the first terminal 241.

The even channels output to the ports 3, 5, 7, 9, 13, and 15 of the first terminal 241 are folded back to the second terminal 242 of the optical arrayed waveguide grating 240 through the ports 2, 4, 6, 8, 12, and 14 of the first terminal 241 adjacent to the ports 3, 5, 7, 9, 13, and 15. The even channels folded back to the second terminal 242 of the optical arrayed waveguide grating 240 and the even channel added at the port 16 of the first terminal 241 are multiplexed into the second optical signal 202 at the optical arrayed waveguide grating 240, and the second optical signal 202 is output through the port 6 of the second terminal 242 of the optical arrayed waveguide grating 240 connected to the third port of the first circulator 212.

The even or odd channel is dropped at the ports 1 of the first terminal 241 and the second terminal 242, and the even or odd channel of a predetermined wavelength is added at the ports 16 of the first terminal 241 and the second terminal 242.

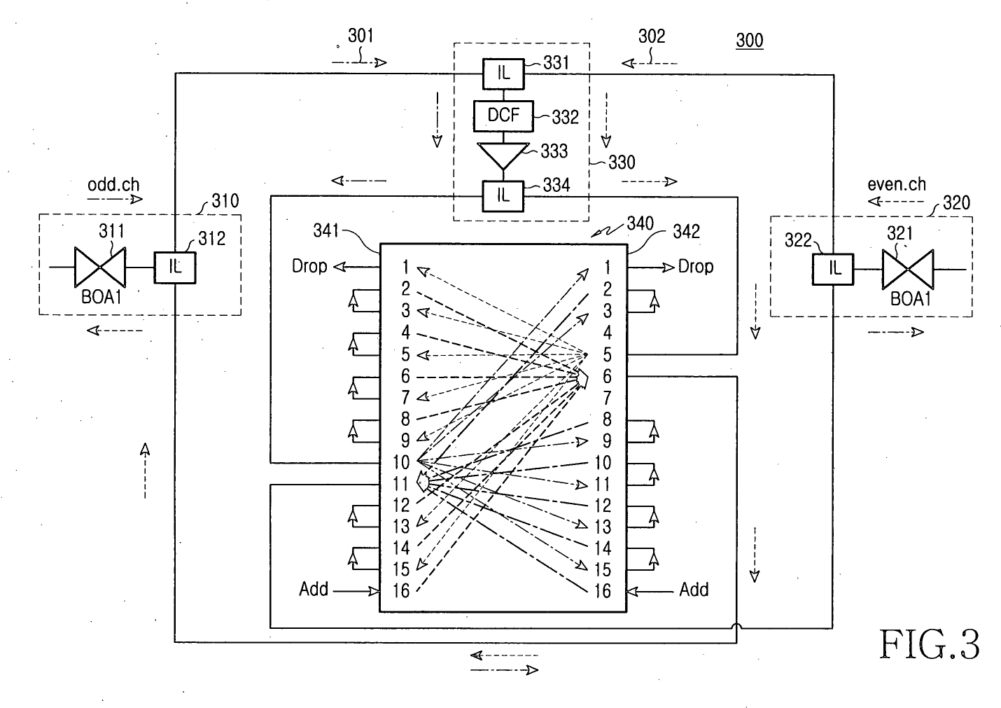

FIG. 3 illustrates a bidirectional add/drop multiplexer 300 according to a second embodiment of the present invention. As shown, the bidirectional add/drop multiplexer 300 includes a first input/output unit 310, a second input/output unit 320, an optical arrayed waveguide grating 340, and an optical combining unit 330.

The first input/output unit 310 includes a second optical amplifier 311 for amplifying a first optical signal 301 and a second optical signal 302, and a third interleaver 312 for outputting the first optical signal 301 amplified by the second optical amplifier 311 to the optical combining unit 330 and outputting the second optical signal 302 output from a second terminal 342 of the optical arrayed waveguide grating 340 to the second optical amplifier 311.

The second input/output unit 320 includes a third optical amplifier 321 for amplifying the first optical signal and the second optical signal 302, and a fourth interleaver 322 for outputting the second optical signal 302 amplified by the third optical amplifier 321 to the optical combining unit 330 and outputting the first optical signal 301 output from a first terminal 341 of the optical arrayed waveguide grating 340 to the third optical amplifier 321.

The optical combining unit 330 includes a first interleaver 331 connected to the first input/output unit 310, and the second input/output unit 320 for inputting the first optical signal 301 and the second optical signal 302 from the first input/output unit 310 and the second input/output unit 320, respectively, to the optical combining unit 330, a second interleaver 334 for outputting the first optical signal 301 input from the first interleaver 331 and outputting the second optical signal 302 to the second terminal 342, a first optical amplifier 333 positioned between the first interleaver 331 and the second interleaver 334 for amplifying the first optical signal 301 and the second optical signal 302 and outputting the amplified first optical signal 301 and the amplified second optical signal 302 to the second interleaver 334, and a dispersion compensating fiber 332 for connecting the first optical amplifier 333 and the first interleaver 331.

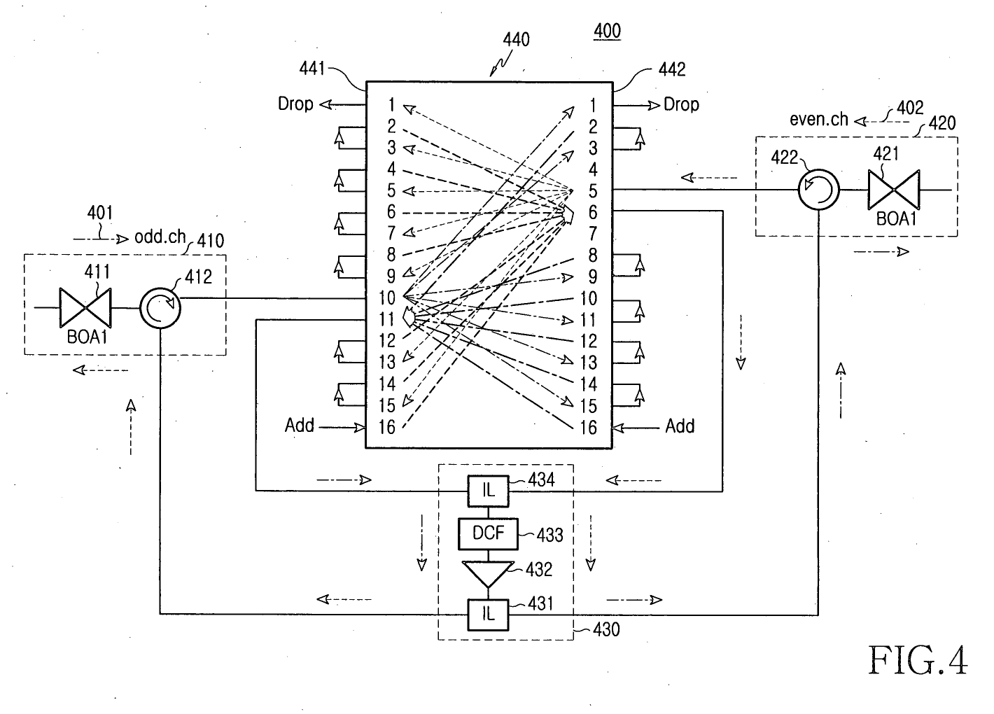

FIG. 4 illustrates a bidirectional add/drop multiplexer 400 according to a third embodiment of the present invention. As shown, the bidirectional add/drop multiplexer 400 includes a first input/output unit 410 for inputting a first optical signal 401 multiplexed from a plurality of odd channels and outputting a second optical signal 402 multiplexed from a plurality of added or dropped even channels, a second input/output unit 420 for outputting the first optical signal 401 multiplexed from a plurality of added or dropped odd channels and inputting the second optical signal 402 multiplexed from a plurality of even channels, an optical arrayed waveguide grating 440 including a first terminal 441 and a second terminal 442, each of which includes a plurality of ports, for multiplexing added or dropped odd channels of the first optical signal 401 input to the first terminal 441 to output the multiplexed odd channels to the first terminal 441, and multiplexing added or dropped even channels of the second optical signal 402 input to the second terminal 442 to output the multiplexed even channels to the second terminal 442, and an optical combining unit 430 for amplifying the first optical signal 401 and the second optical signal 402 input from the optical arrayed waveguide grating 440 and outputting the amplified first optical signal 401 to the second input/output unit 420 and the amplified second optical signal 402 to the first input/output unit 410.

The optical combining unit 430 includes a first interleaver 434 to which the first optical signal 401 and the second optical signal 402 where a channel is added or dropped are input, a second interleaver 431 for outputting the first optical signal 401 input to the first interleaver 434 to the first input/output unit 410 and the second optical signal 402 to the second input/output unit 420, a first optical amplifier 432 positioned between the first interleaver 434 and the second interleaver 431 for amplifying the first optical signal 401 and the second optical signal 402 to output the amplified first optical signal 401 and the amplified second optical signal 402 to the second interleaver 431, and a dispersion compensating fiber 433 for connecting the first optical amplifier 432 and the first interleaver 434.

The first input/output unit 410 includes a second optical amplifier 411 for amplifying the first optical signal 401 and the second optical signal 402, and a first circulator 412 for outputting the first optical signal 401 amplified by the second optical amplifier 411 to the optical arrayed waveguide grating 440 and the second optical signal 402 input from the optical combining unit 430 to the second optical amplifier 411.

The second input/output unit 420 includes a third optical amplifier 421 for amplifying the first optical signal 401 and the second optical signal 402, and a second circulator 422 for outputting the second optical signal 402 amplified by the third optical amplifier 421 to the optical arrayed waveguide grating 440 and the first optical signal 401 input from the optical combining unit 430 to the third optical amplifier 421.

As is apparent from the foregoing, the present invention has an advantage in that it can be implemented with a small number of optical devices and optical amplifiers, it can be effectively applied to a node configuration of a mesh-type ring-shaped network. In addition, the generation of a relative intensity noise at a bidirectional system can be prevented using the crosstalk characteristic of an interleaver and an optical arrayed waveguide grating.

While the invention has been shown and described with reference to preferred embodiments thereof, it will be understood by those skilled in the art that various changes in form and details may be made therein without departing from the spirit and scope of the invention.

What is claimed is:

1. A bidirectional add/drop multiplexer comprising:
a first input/output unit for inputting a first optical signal multiplexed from a plurality of odd channels and outputting a second optical signal multiplexed from a plurality of added or dropped even channels;
a second input/output unit for outputting the first optical signal multiplexed from a plurality of added or dropped odd channels and outputting the second optical signal multiplexed from a plurality of even channels;
an optical arrayed waveguide grating including a first terminal and a second terminal, each of which includes a plurality of ports, for multiplexing the added or dropped odd channels of the first optical signal input to the first terminal, outputting the multiplexed even channels to the second input/output unit through the first terminal, multiplexing the added or dropped even channels of the second optical signal input to the second terminal, and outputting the multiplexed even channels to the first input/output unit through the second terminal; and
an optical combining unit for amplifying the first optical signal and the second optical signal input from the first input/output unit and the second input/output unit, and outputting the first optical signal to the first terminal and the second optical signal to the second terminal.

2. The bidirectional add/drop multiplexer of claim 1, wherein the optical combining unit comprises:
a first interleaver coupled to the first input/output unit and the second input/output unit for inputting the first optical signal and the second optical signal from the first input/output unit and the second input/output unit to the optical combining unit;
a second interleaver for outputting the optical signal input from the first interleaver to the first terminal and the second optical signal to the second terminal;
a first optical amplifier disposed between the first interleaver and the second interleaver for amplifying the first optical signal and the second optical signal, and outputting the amplified first optical signal and the amplified second optical signal to the second interleaver; and
a dispersion compensating fiber for coupling the first optical amplifier and the first interleaver.

3. The bidirectional add/drop multiplexer of claim 1, wherein the first input/output unit comprises:
a second optical amplifier for amplifying the first optical signal and the second optical signal; and
a first circulator for outputting the first optical signal amplified by the second optical amplifier to the optical combining unit and the second optical signal output from the second terminal of the optical arrayed waveguide grating to the second optical amplifier.

4. The bidirectional add/drop multiplexer of claim 1, wherein the second input/output unit comprises:
a third optical amplifier for amplifying the first optical signal and the second optical signal; and
a second circulator for outputting the second optical signal amplified by the third optical amplifier to the optical combining unit and the first optical signal output from the first terminal of the optical arrayed waveguide grating to the third optical amplifier.

5. The bidirectional add/drop multiplexer of claim 1, wherein the first input/output unit comprises:
a second optical amplifier for amplifying the first optical signal and the second optical signal; and
a third interleaver for outputting the first optical signal amplified by the second optical amplifier to the optical combining unit and the second optical signal output from the second terminal of the optical arrayed waveguide grating to the second optical amplifier.

6. The bidirectional add/drop multiplexer of claim 1, wherein the second input/output unit comprises:
a third optical amplifier for amplifying the first optical signal and the second optical signal; and
a fourth interleaver for outputting the second optical signal amplified by the third optical amplifier to the optical combining unit and the first optical signal output from the first terminal of the optical arrayed waveguide grating to the third optical amplifier.

7. A bidirectional add/drop multiplexer comprising:
a first input/output unit for inputting a first optical signal multiplexed from a plurality of odd channels and outputting a second optical signal multiplexed from a plurality of added or dropped even channels;
a second input/output unit for outputting the first optical signal multiplexed from a plurality of added or dropped odd channels and outputting the second optical signal multiplexed from a plurality of even channels;
an optical arrayed waveguide grating including a first terminal and a second terminal, each of which includes a plurality of ports, for multiplexing the added or dropped odd channels of the first optical signal input to the first terminal, outputting the multiplexed even channels to the first terminal, multiplexing the added or dropped even channels of the second optical signal input to the second terminal, and outputting the multiplexed even channels to the second terminal; and
an optical combining unit for amplifying the first optical signal and the second optical signal input from the optical arrayed waveguide grating, and outputting the first optical signal to the second input/output unit and the second optical signal to the first input/output unit.

8. The bidirectional add/drop multiplexer of claim 7, wherein the optical combining unit comprises:
a first interleaver to which the first optical signal and the second optical signal where a channel is added or dropped are input;
a second interleaver for outputting the optical signal input from the first interleaver to the first input/output unit and the second optical signal to the second input/output unit;
a first optical amplifier disposed between the first interleaver and the second interleaver for amplifying the first optical signal and the second optical signal, and outputting the amplified first optical signal and the amplified second optical signal to the second interleaver; and
a dispersion compensating fiber for coupling the first optical amplifier and the first interleaver.

9. The bidirectional add/drop multiplexer of claim 7, wherein the first input/output unit comprises:
a second optical amplifier for amplifying the first optical signal and the second optical signal; and
a first circulator for outputting the first optical signal amplified by the second optical amplifier to the optical arrayed waveguide grating and the second optical signal input from the optical combining unit to the second optical amplifier.

10. The bidirectional add/drop multiplexer of claim 7, wherein the second input/output unit comprises:
a third optical amplifier for amplifying the first optical signal and the second optical signal; and
a second circulator for outputting the second optical signal amplified by the third optical amplifier to the optical arrayed waveguide grating and the first optical signal input from the optical combining unit to the third optical amplifier.
